(19) United States
(12) Patent Application Publication
(10) Pub. No.: US 2022/0112899 A1
(43) Pub. Date: Apr. 14, 2022

(54) DEVICE FOR COMPRESSING A FLUID DRIVEN BY AN ELECTRIC MACHINE WITH A ROTOR EQUIPPED WITH A SOLID CYLINDRICAL MAGNET

(71) Applicant: IFP Energies nouvelles, Rueil-Malmaison (FR)

(72) Inventors: Fabrice LE BERR, RUEIL-MALMAISON CEDEX (FR); Misa MILOSAVLJEVIC, RUEIL-MALMAISON CEDEX (FR); Denis GROSJEAN, RUEIL-MALMAISON CEDEX (FR)

(21) Appl. No.: 17/428,367

(22) PCT Filed: Jan. 14, 2020
(86) PCT No.: PCT/EP2020/050744

§ 371 Date: Aug. 4, 2021

(30) Foreign Application Priority Data
Feb. 4, 2019 (FR) 1901073

(51) Int. Cl. F04D 25/06; F04D 29/62; H02K 1/2733; H02K 1/28

(52) U.S. Cl. CPC F04D 25/06; H02K 1/28; H02K 1/2733; F04D 29/624

(57) ABSTRACT

The present invention relates to a compression device driven by an electric machine, for which a rotor (4) comprises a cylindrical magnet (5) and a binding ring (6), preferably non-magnetic. According to the invention, cylindrical magnet (5) is solid and cylindrical magnet (5) is fastened to a support piece (7) by means of binding ring (6), support piece (7) being fastened to one end of compression shaft (3).

### FIELD OF THE INVENTION

The present invention relates to the field of compression devices driven by an electric machine, in particular the invention concerns a turbocharger driven by an electric machine.

It notably relates to a device for compressing a gaseous fluid, air here, by means of a compressor, alone or associated with a turbine so as to form a turbocharger, prior to sending it to any device and, more particularly, to the intake of an internal-combustion engine.

Indeed, as is widely known, the power delivered by an internal-combustion engine depends on the amount of air fed to the combustion chamber of this engine, which amount of air is itself proportional to the density of this air.

Thus, it is usual to increase this amount of air through compression of the outside air before it is allowed into this combustion chamber when high power is required. This operation, known as turbocharging, can be carried out using any means such as a compressor alone, electrically driven by an electric machine (electrified compressor), or a compressor associated with a turbine and an electric machine so as to form an electrified turbocharger.

### BACKGROUND OF THE INVENTION

In the aforementioned two cases, the electric machine associated with the compressor can be of different types.

One is an electric machine with a small air gap and windings close to the rotor, which provides optimal guidance of the magnetic flux and optimized efficiency. This type of electric machine has the advantage of a certain compactness, which may sometimes be a problem as regards cooling thereof and requires a specific system for carrying off heat losses.

In order not to be intrusive on the air intake of the compressor, this type of electric machine is conventionally positioned on the back of the compressor in the case of an electrified compressor, or between the compressor and the turbine in the case of an electrified turbocharger, despite the presence of an unfavourable thermal environment in the latter case, since close to the turbine. Generally, the link between the compressor, the turbine and the electric machine is rigid. This type of machine can also be positioned on the compressor side, but relatively far from the air intake so as not to disturb it. The link between the compressor and the electric machine is then rigid or it is provided by a mechanical or a magnetic coupling.

This type of system is described in more detail in patents US-2014/0,373,532, U.S. Pat. Nos. 8,157,543, 8,882,478, US-2010/0,247,342, U.S. Pat. Nos. 6,449,950, 7,360,361, EP-0,874,953 or EP-0,912,821.

Another type of machine is an electric machine with a large air gap that may sometimes be several centimeters long, so as to allow passage of the working fluid therethrough, thus enabling integration as close as possible to the compression systems, in a significantly more favourable thermal environment.

This electric machine layout however involves the drawback of disturbing and limiting the passage of the magnetic flux between the rotor and the stator through the large air gap, and thereby contributes to limiting the intrinsic efficiency of the electric machine and the specific performances thereof (power-to-weight ratio and power density). The high losses with this type of design also require specific cooling to discharge the calories from the rotor and the stator or to limit the specific performances.

This type of electric machine is notably described in patents EP-1,995,429, US-2013/169,074 or US-2013/043,745.

A third type of electric machine is a machine provided with a stator grid, i.e. an electric machine having a stator with stator teeth around which coils are mounted, these stator teeth having large dimensions to allow passage of the air stream. Stator grid machines are electric machines with a small air gap and windings positioned away from the rotor. This type of electric machine can be arranged at the compressor intake. Such a stator grid machine is notably described in patent applications WO-2013/050,577 and FR-3,048,022.

One problem related to the electrification of compressors concerns the design of the rotor and its connection to the compressor shaft. This design is often complex (use of screws) and not readily compatible with an industrial mass production manufacturing process.

Patent application No. FR-17/61,576 details several electric rotor structures and structures for mounting the rotor on the shaft of a turbocharger, by adding a rotor to a shaft opening onto the compressor side. These structures are interesting for integration of rotors on already existing turbochargers. However, these structures are most often not readily compatible with an industrial mass production manufacturing process, considering the manufacturing tolerances and the rotor balancing operations required in order to obtain such a system. Furthermore, these solutions require machining a bore within a magnet, which is complex and reduces the magnetic performances of the magnet.

### SUMMARY OF THE INVENTION

In order to reduce the complexity of the manufacturing and assembly method, and to be compatible with an industrial mass production manufacturing process, the present invention relates to a compression device driven by an electric machine, for which the rotor comprises a cylindrical magnet and a preferably non-magnetic binding ring. According to the invention, the cylindrical magnet is solid (i.e. without bores) and the cylindrical magnet is fastened to a support piece by means of the binding ring, the support piece being fastened to one end of the compression shaft. Thus, this solution requires no bore in the cylindrical magnet, which simplifies the manufacture of the compression device and allows the magnetic performances of the magnet to be increased. The performances of the electric machine can therefore be increased and/or the dimensions of the electric machine can be reduced. Furthermore, mounting of the rotor with the compression shaft is simplified.

The invention relates to a fluid compression device driven by an electric machine, said electric machine comprising a rotor and a stator, said rotor comprising a cylindrical magnet and a binding ring, said compression device comprising a compression shaft on which at least one compressor wheel is mounted, and a support piece being fastened to one end of said compression shaft. Said cylindrical magnet is a solid piece, and said rotor is fastened to said support piece by means of said binding ring surrounding at least part of said support piece.

According to an embodiment, said support piece is fastened to said compression shaft by a threaded connection.

According to an aspect, said support piece comprises means for handling said support piece.

According to an implementation of the invention, said support piece comprises a cylindrical portion inserted in said compressor wheel.

According to a feature, said support piece comprises a cylindrical portion for said binding ring.

Advantageously, said binding ring is made of a non-magnetic material, preferably titanium or carbon.

Preferably, said rotor comprises a non-magnetic stop between said cylindrical magnet and said support piece.

According to an aspect, the outside diameter of said rotor is less than or equal to the diameter of the nose of said compressor wheel.

Advantageously, said compression device is a turbocharger combining a turbine and a compressor, notably for an internal-combustion engine, or a microturbine.

Preferably, said electric machine is arranged in the gas intake of said turbocharger.

According to an embodiment option, said electric machine is a stator grid machine.

Furthermore, the invention relates to a method of manufacturing a compression device driven by an electric machine, said electric machine comprising a rotor and a stator, said compression device comprising a compression shaft on which at least one compressor wheel is mounted. For this method, the following steps are carried out:

a) fastening said solid cylindrical magnet onto said support piece by means of said binding ring that surrounds said cylindrical magnet and at least a portion of said support piece,

b) mounting said compressor wheel onto said compression shaft,

c) fastening said support piece onto one end of said compression shaft, notably by means of a threaded connection.

Furthermore, the invention relates to a method of manufacturing a compression device driven by an electric machine, said electric machine comprising a rotor and a stator, said compression device comprising a compression shaft on which at least one compressor wheel is mounted. For this method, the following steps are carried out:

a) mounting said compressor wheel onto said compression shaft,

b) fastening said support piece with said rotor onto one end of said compression shaft, notably by means of a threaded connection, step b) comprising the substep as follows:
i) fastening said solid cylindrical magnet onto said support piece by means of said binding ring that surrounds said cylindrical magnet and at least a portion of said support piece.

### BRIEF DESCRIPTION OF THE SOLE FIGURE

Other features and advantages of the device and of the method according to the invention will be clear from reading the description hereafter of embodiments, given by way of non limitative example, with reference to the accompanying FIGURE wherein:

FIG. 1 illustrates a compression device according to an embodiment of the invention.

### DETAILED DESCRIPTION OF THE INVENTION

The present invention relates to a device for compressing a fluid, notably gas, driven by an electric machine. In other words, the invention relates to the assembly made up of the electric machine and the compression device. Preferably, the compression device is intended to compress air.

The fluid compression device comprises a shaft, referred to as compression shaft, on which a compressor wheel (also referred to as blade) is mounted.

The electric machine comprises a rotor and a stator. The rotor is connected to the compression shaft by means of a support piece so as to transmit or draw the torque of the electric machine to the compression shaft and the compressor wheel, and vice versa. The support piece is therefore fastened, on the one hand, to one end of the compression shaft and, on the other hand, to the rotor. The support piece can be made of a magnetic or non-magnetic material.

The rotor comprises at least:
a cylindrical magnet, the magnet interacts with stator coils so as to generate the rotational motion of the rotor, and
a binding ring (shrink ring), preferably made of a non-magnetic material, titanium or carbon for example, for compressing the magnet and axially retaining the cylindrical magnet of the rotor, and the binding ring can have a substantially cylindrical shape surrounding the cylindrical magnet. Moreover, the non-magnetic material prevents magnetic leakage.

According to the invention, the cylindrical magnet is a solid piece. In other words, the cylindrical magnet is a solid cylinder without holes, bores or perforations, etc. This solution therefore requires no machining (boring for example) of the cylindrical magnet, which simplifies the manufacture of the compression device and increases the magnetic performances of the magnet (the volume of the magnet is significant). Therefore, the performances of the electric machine can be increased and/or the dimensions of the electric machine can be reduced. Preferably, the rotor according to the invention can radially comprise at most the following elements: cylindrical magnet and binding ring.

Furthermore, according to the invention, the rotor is fastened to the support piece by means of the binding ring of the rotor. In other words, the cylindrical ring surrounds on the one hand the cylindrical magnet and, on the other hand, a portion of the support piece. Thus, mounting of the magnet onto the support piece is simplified. Assembly of the compression device and of the rotor is simplified thereby and can be carried out industrially.

According to an embodiment of the invention, the support piece can be fastened to the compression shaft by means of a threaded connection. For example, the end of the compression shaft can comprise a thread and the support piece can comprise a tapped bore.

For this embodiment, the support piece can comprise means for gripping/handling the support piece in order to rotate the support piece and therefore to achieve fastening by the threaded connection. These gripping/handling means may notably be orifices for inserting tools, sections for forming a handling tip, etc.

According to an aspect of the invention, the support piece can comprise a cylindrical portion inserted in the compressor wheel. This cylindrical portion surrounds the compression shaft and it is inserted in the bore of the compressor wheel. This cylindrical portion provides long centering of the rotor with respect to the compression shaft, which allows better coaxiality of the compression shaft with the support piece. The outside diameter of the cylindrical portion can be reduced in relation to the outside diameter of the rotor.

Advantageously, the cylindrical portion surrounding the compression shaft can have an axial length ranging between 2 and 3 times the diameter of the compression shaft, so as to provide optimized long centering.

According to a first variant of this embodiment, the axial length of the cylindrical portion substantially corresponds to the axial length of the compressor wheel, in order to allow maximum long centering and to stiffen the compressor wheel, in particular for high rotational speeds. This configuration notably allows to stiffen the portion of the shaft below the compressor wheel, which can be a critical point for some bending modes.

According to an embodiment option of the invention, the support piece can comprise a cylindrical portion intended for positioning of the binding ring. This cylindrical portion can advantageously have an outside diameter equal to the outside diameter of the cylindrical magnet.

For this embodiment, the length of the ring can be substantially equal to the cumulative length of the cylindrical magnet and the length of the cylindrical portion of the support piece intended for positioning the binding ring.

According to an aspect of the invention, the rotor can further comprise a non-magnetic stop on at least one side of the magnet (longitudinally). This non-magnetic stop prevents magnetic leakage from the magnet to the support piece and the compression shaft. The non-magnetic stop can also act as a thermal barrier protecting the temperature-sensitive magnet.

For example, the rotor can comprise a non-magnetic stop between the support piece and the cylindrical magnet. The non-magnetic stop can then have substantially the shape of a disc of diameter equal to the diameter of the cylindrical magnet. Thus, magnetic leakage from the cylindrical magnet to the support piece is prevented.

According to an embodiment option, the length of the binding ring surrounding the support piece can be greater than 3 mm so as to sufficiently secure the rotor.

Furthermore, the length of the binding ring surrounding the support piece can be less than the length of the binding ring surrounding the magnet, so as to limit the axial space requirement.

Preferably, the electric machine can be mounted on the intake side of the compression device.

According to an embodiment of the invention, the outside diameter of the rotor (here the binding ring) can be less than or equal to the diameter of the compressor wheel nose. The gas flow at the compression device inlet is thus not hindered by the rotor shaft.

According to an implementation of the invention, the compression device is a turbocharger, notably for an internal-combustion engine of a vehicle. It is then a turbocharger driven by an electric machine. In this case, the compression shaft corresponds to the turbocharger shaft that connects the turbocharger turbine to the turbocharger compressor. The electric machine thus drives both the compressor and the turbine.

According to a variant of this implementation of the invention, the electric machine can be arranged in the gas (generally air) intake of the turbocharger system. This solution involves a double advantage: the electric machine can be cooled by the intake gas stream, and the intake gas is heated by the electric machine, which may be favourable for some operating modes of the internal-combustion engine.

Preferably, the electric machine can be a stator grid electric machine, i.e. an electric machine having a stator with stator teeth around which coils are mounted, and these stator teeth have large dimensions to allow passage of the air stream. Such a stator grid machine is notably described in patent applications WO-2013/050,577 and FR-3,048,022.

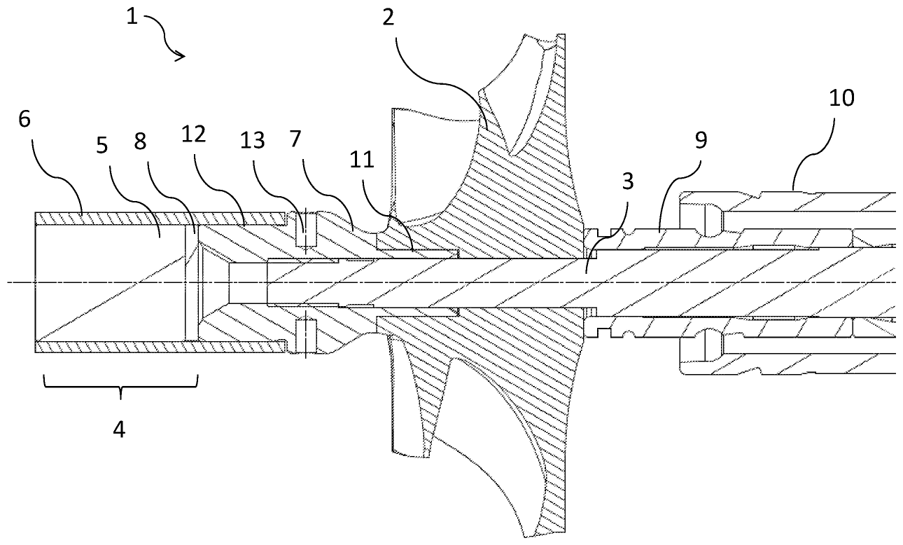

FIG. 1 schematically illustrates, by way of non-limitative example, an embodiment of the invention. FIG. 1 is a sectional view of compression device 1 driven by an electric machine. Compression device 1 comprises a compression shaft 3 on which a compressor wheel 2 is mounted. The end of compression shaft 3 is threaded for mounting and securing a support piece 7. Rotor 4 is arranged at the end of support piece 7. Rotor 4 consists of a solid (no bore) cylindrical magnet 5 and a binding ring 6. Rotor 4 further comprises a non-magnetic stop 8 having the shape of a disc. Stop 8 is arranged between cylindrical magnet 5 and support piece 7. Binding ring 6 also surrounds a cylindrical portion 12 of support piece 7 so as to connect rotor 4 and support piece 7. The outside diameter of binding ring 6 is substantially equal to the diameter of the nose of compressor wheel 2. The length of ring 6 is substantially equal to the sum of the length of cylindrical magnet 5 and the length of cylindrical portion 12 of support piece 7. At the other end thereof, support piece 7 has a small-diameter cylindrical portion 11 inserted in compressor wheel 2. Furthermore, support piece 7 comprises blind holes 13 intended for handling support piece 7 for fastening thereof to compression shaft 3, notably by means of operating tools (not shown). On one side, compressor wheel 2 abuts against support piece 7. On the other side, compressor wheel 2 abuts against a guide system 9, for example the inner ring of a bearing whose outer ring 10 is shown.

Variants of this illustrated embodiment may be considered; for example, cylindrical portion 11 may have the same length as compressor wheel 2, the length of cylindrical portion 11 may be greater than or equal to the length of the compressor wheel, support piece 7 may have no cylindrical portion 11, the rotor may have no non-magnetic stop 8, etc.

Furthermore, the invention relates to a method of manufacturing a compression device driven by an electric machine, said electric machine comprising a rotor and a stator, and said compression device comprising a compression shaft and a compressor wheel. For this method, the following steps are carried out:

a) fastening the solid cylindrical magnet onto the support piece by means of a binding ring that surrounds the cylindrical magnet and at least a portion of the support piece;

b) mounting the compressor wheel onto the compression shaft;

c) fastening the support piece onto one end of the compression shaft, notably by means of a threaded connection.

Alternatively, the steps of the method can be as follows:

a) mounting the compressor wheel onto the compression shaft,

b) fastening the support piece with the rotor onto one end of the compression shaft, notably by means of a threaded connection, step b) comprising the substep as follows:
i) fastening the solid cylindrical magnet onto the support piece by means of a binding ring that surrounds the cylindrical magnet and at least a portion of the support piece.

Advantageously, the manufacturing method can be intended for the manufacture of a compression device according to any one of the variants or variant combinations described above. For example, the manufacturing method can be intended for the manufacture of a compression device as described in connection with FIG. 1.

For the embodiment where fastening of the support piece and the compression shaft is achieved by means of a threaded connection, fastening can be carried out by rotating the support piece, notably using a means for gripping/handling the support piece.

According to an embodiment, the step of mounting the compressor wheel onto the compression shaft can comprise inserting a cylindrical portion of the support piece into the compressor wheel.

According to an implementation of the invention, the step of fastening the cylindrical magnet onto the support piece by means of the binding ring can comprise inserting a non-magnetic stop between the cylindrical magnet and the support piece.

According to an embodiment of the method, the assembly made up of the compression device, or possibly the turbocharger, and the electric machine can be installed in an air loop of an internal-combustion engine.

Advantageously, the electric machine can be arranged in the air intake pipe, so that the air stream entering the compression device first flows through the electric machine. This solution has a double advantage: the electric machine can be cooled by the intake gas stream and the intake gas is heated by the electric machine, which can be favourable for some operating modes of the internal-combustion engine.

The manufacturing method may further comprise a step of installing the stator around the rotor.

Advantageously, the manufacturing method according to the invention can concern the electrification of a compression device or of a conventional turbocharger (equipped with a compressor wheel and a compression shaft, but initially without an electric drive). Therefore, the compressor wheel and the compression shaft can be a wheel and a shaft for which steps a) to c) described above are carried out.

In this case, the method can comprise an additional step of replacing the compression shaft with a longer compression shaft.

Besides, the invention is also suited for energy production systems such as microturbines.

The invention provides the following functional advantages, it allows to:
create a magnetic rotor allowing the shaft to be rotated through the generation of a rotating magnetic field by means of a stator comprising windings (three-phase windings for example),
ensure the mechanical strength of the rotor assembly, notably with respect to the centrifugal forces applied upon rotation, notably by means of the binding ring,
guarantee good electrical performances, in terms of power as well as efficiency, so as to limit internal heating of the rotor (and therefore demagnetization) and to simplify cooling thereof, notably by means of the solid cylindrical magnet,
observe a high level of concentricity between the electric rotor and the turbocharger shaft so as to obtain a complete mechanical system (turbocharger shaft with electric machine rotor) that can be balanced with minimum unbalance,
have a structure compatible with the assembly of the compressor wheel on the turbocharger shaft,
tighten the compressor wheel and preload the roller bearings of the turbocharger, and
be compatible with an electric turbocharger mass production tooling and manufacturing method.

1. A fluid compression device driven by an electric machine, the electric machine comprising a rotor and a stator, the rotor comprising a cylindrical magnet and a binding ring, the compression device comprising a compression shaft on which at least one compressor wheel is mounted, and a support piece being fastened to one end of the compression shaft, wherein the cylindrical magnet is a solid piece, and the rotor is fastened to the support piece by means of the binding ring surrounding at least part of the support piece.

2. A compression device as claimed in claim 1, wherein the support piece is fastened to the compression shaft by a threaded connection.

3. A compression device as claimed in claim 1, wherein support piece comprises means for handling the support piece.

4. A compression device as claimed in claim 1, wherein the support piece comprises a cylindrical portion inserted in the compressor wheel.

5. A compression device as claimed in claim 1, wherein the support piece comprises a cylindrical portion for the binding ring.

6. A compression device as claimed in claim 1, wherein the binding ring is made of a non-magnetic material, preferably titanium or carbon.

7. A compression device as claimed in claim 1, wherein the rotor comprises a non-magnetic stop between the cylindrical magnet and the support piece.

8. A compression device as claimed in claim 1, wherein the outside diameter of the rotor is less than or equal to the diameter of the nose of the compressor wheel.

9. A compression device as claimed in claim 1, wherein the compression device is a turbocharger combining a turbine and a compressor, notably for an internal-combustion engine, or a microturbine.

10. A compression device as claimed in claim 9, wherein the electric machine is arranged in the gas intake of the turbocharger.

11. A compression device as claimed in claim 1, wherein the electric machine is a stator grid machine.

12. A method of manufacturing a compression device driven by an electric machine, the electric machine comprising a rotor and a stator, the compression device comprising a compression shaft on which at least one compressor wheel is mounted, wherein the following steps are carried out:
a) fastening the solid cylindrical magnet onto the support piece by means of the binding ring that surrounds the cylindrical magnet and at least a portion of the support piece,
b) mounting the compressor wheel onto the compression shaft,
c) fastening the support piece onto one end of the compression shaft, notably by means of a threaded connection.

13. A method of manufacturing a compression device driven by an electric machine, the electric machine comprising a rotor and a stator, the compression device comprising a compression shaft, on which at least one compressor wheel is mounted, wherein the following steps are carried out:
a) mounting the compressor wheel onto the compression shaft,
b) fastening the support piece with the rotor onto one end of the compression shaft, notably by means of a threaded connection, step b) comprising the substep as follows:
i) fastening the solid cylindrical magnet onto the support piece by means of the binding ring that surrounds the cylindrical magnet and at least a portion of the support piece.
